(19) United States
(12) Patent Application Publication
(10) Pub. No.: US 2014/0368330 A1
(43) Pub. Date: Dec. 18, 2014

(54) MOBILE BODY COMMUNICATION DEVICE AND TRAVEL ASSISTANCE METHOD

(71) Applicant: SANYO Electric Co., Ltd., Moriguchi-shi, Osaka (JP)

(72) Inventors: Kazuhiko Watanabe, Tottori (JP); Takahiro Ishida, Tottori (JP)

(73) Assignee: SANYO Electric C., Ltd,, Moriguchi-shi, Osaka (JP)

(21) Appl. No.: 14/367,106

(22) PCT Filed: Oct. 25, 2012
(86) PCT No.: PCT/JP2012/077532

§ 371 Date: Jun. 19, 2014

(30) Foreign Application Priority Data
Dec. 22, 2011 (JP) 2011-281821

(51) Int. Cl. G08G 1/16; B60Q 1/34

(52) U.S. Cl. CPC G08G 1/16; B60Q 1/34
USPC 340/475

(57) ABSTRACT

A mobile communication device is provided in a mobile object, and is capable of providing turn collision prevention support, so as to prevent a collision with another mobile object at a risk of collision when the mobile object turns. The mobile communication device includes: a communication unit for receiving information that includes information indicating a signal indication of a traffic signal; and a control unit for determining a notification mode to provide a predetermined notification to draw an attention via a notification unit when turning. The control unit determines the notification mode regardless of whether or not the another mobile object is present when the signal indication of the traffic signal for the traveling direction of the mobile object is an advance-prohibited signal indication with turning-permitted signal indication. Thus the device achieves smooth traffic and preventing excessive support through turn collision prevention support depending on a signal indication.

### TECHNICAL FIELD

The present invention relates to a mobile communication device and a traveling support method that are capable of providing a turn collision prevention support to prevent a collision with another mobile object at the time of turning.

### BACKGROUND ART

In recent years, researches and developments have been made on intelligent transport systems (hereinafter referred to as “ITS”) aiming at solving road traffic problems such as traffic accidents and congestion through information networking among people, roads, and vehicles by using the information communication technology. In the ITS, particularly, the modes of automotive wireless communications in the field that deals with safe driving support systems can be roughly classified into a road-to-vehicle communication and a vehicle-to-vehicle communication. The road-to-vehicle communication permits roadside devices to communicate information to/from vehicles, whereas the vehicle-to-vehicle communication permits vehicles to communicate information with each other.

Information to be transmitted to vehicles from roadside devices through the road-to-vehicle communication is considered to include intersection information and traffic signal information. The intersection information includes identification information for identifying an intersection, and the traffic signal information includes identification information for identifying a traffic signal, and information indicating at least a portion part of the cycle of signal indication of a traffic signal (the information indicating at least a part of the cycle of the signal indication including, for example, current signal indication information of the traffic signal (information indicating the indication color of the traffic signal), next signal indication information, and information indicating a time till the transition to the signal indication). A large number of devices that support drivers by using the intersection information and the traffic signal information obtained in this manner have been proposed.

There may be accidents of collision with a third vehicle present in a blind spot formed by other vehicles at the time of turning at an intersection or the like. Such an accident is described below in detail with reference to FIG. 5. Referring to FIG. 5, each road is a left-hand traffic road with two lanes in one traffic direction. A vehicle A will turn right, a vehicle B will turn right, and a vehicle C will travel straight. In addition, it is assumed that both of signal indications of a traffic signal S1 and a traffic signal S2 show advance-permitted signal indication (green signal indication). When the vehicle B is a large vehicle such as a bus in such a situation, for example, what is called a blind area, which is an area where the driver of the vehicle A cannot visually recognize the presence of other vehicles, is formed behind the vehicle B. There is a high risk of collision with the vehicle C traveling straight through the blind area when the driver of the vehicle A performs an operation to turn right. When another vehicle is present in a blind area, therefore, it is desired to give a support to prevent a collision with this vehicle.

Accordingly, the vehicle warning device described in Patent Literature 1 is configured in such a way that, in order to prevent a collision between a first vehicle and a second vehicle each of which cannot recognize the other vehicle (vehicle which may end up with a collision) through a blind spot formed by the local vehicle, the driver of the first vehicle and/or the driver of the second vehicle is notified of the presence of the other vehicle. This makes it possible to permit the driver of at least one vehicle to be aware of the presence of the other vehicle, thereby preventing a collision at the time of turning.

### CITATION LIST

[PTL 1] JP 2011-164760 A

### SUMMARY OF INVENTION

### Technical Problem

When each of the signal indication of the traffic signal for the traveling direction of a right-turning vehicle (vehicle A in FIG. 5) and the signal indication of the traffic signal for the traveling direction of a straight-traveling vehicle (vehicle C in FIG. 5) is an advance-permitted signal indication (green signal indication), the vehicle A turning right has a risk of colliding with the vehicle C. In such a case, therefore, it is desired to give the above-mentioned support for turn collision prevention. However, when the signal indication of the traffic signal for the traveling direction of the right-turning vehicle and the signal indication of the traffic signal for the traveling direction of the straight-traveling vehicle are different from each other, it may be unnecessary to give the support for turn collision prevention.

In other words, when the signal indication of the traffic signal for the traveling direction of the vehicle A is an advance-prohibited signal indication with turning-permitted signal indication (red signal indication with a right-turn arrow) as illustrated in FIG. 6, the signal indication of the traffic signal for the traveling direction of the vehicle C is an advance-prohibited signal indication (red signal indication), so that it is expected that the vehicle C stops at the intersection. Therefore, giving the support for turn collision prevention in such a circumstance may cause the driver of the vehicle A to misinterpret that the signal indication of the traffic signal for the traveling direction of the vehicle C is the advance-permitted signal indication. This may interfere with a smooth traffic flow, or may become an excessive support so that the driver of the vehicle A may feel uncomfortable.

In light of the above-mentioned problems, it is an object of the present invention to provide a mobile communication device and a traveling support method that give a support for turn collision prevention depending on the signal indication of a traffic signal for the traveling direction of a local vehicle, to thereby achieve smooth traffic and prevent an excessive support.

### Solution to Problem

In order to achieve the above-mentioned object, according to one embodiment of the present invention, there is provided a mobile communication device provided in a mobile object and capable of providing a turn collision prevention support to prevent a collision with another mobile object at a risk of collision when the mobile object turns, the mobile communication device including: a communication unit for receiving information including information indicating a signal indication of a traffic signal; and a control unit for determining a notification mode to provide a predetermined notification to draw an attention at a time of turning via a notification unit, in which when the signal indication of the traffic signal in a traveling direction of the mobile object is an advance-prohibited signal indication with turning-permitted signal indication, the control unit determines the notification mode regardless of whether or not the another mobile object is present.

Further, according to one embodiment of the present invention, in the mobile communication device having the above-mentioned structure, it is desired that the control unit further determine whether or not the another mobile object is stoppable before colliding with the mobile object, and determines the notification mode regardless of whether or not the another mobile object is present only when the signal indication of the traffic signal in the traveling direction of the mobile object is the advance-prohibited signal indication with turning-permitted signal indication, and when it is determined that the another mobile object is stoppable before colliding with the mobile object.

Further, according to one embodiment of the present invention, in the mobile communication device having the above-mentioned structure, it is desired that the another mobile object be a vehicle present in a sensing area.

Further, according to one embodiment of the present invention, in the mobile communication device having the above-mentioned structure, it is desired that the traffic signal be ahead of the mobile object.

Further, according to one embodiment of the present invention, in the mobile communication device having the above-mentioned structure, it is desired that when the signal indication of the traffic signal in the traveling direction of the mobile object is an advance-permitted signal indication or a stop signal indication, the control unit determine the notification mode based on presence of the another mobile object.

Further, according to one embodiment of the present invention, in the mobile communication device having the above-mentioned structure, it is desired that when the signal indication of the traffic signal in the traveling direction of the mobile object is an advance-prohibited signal indication, the control unit provide a support to prevent overlooking of the traffic signal.

In order to achieve the above-mentioned object, according to one embodiment of the present invention, there is provided a traveling support method, including the steps of: acquiring information including information indicating a signal indication of a traffic signal; determining whether or not the signal indication of the traffic signal in a traveling direction of the mobile object is an advance-prohibited signal indication with turning-permitted signal indication; determining a notification mode regardless of whether or not the another mobile object is present when the signal indication of the traffic signal in the traveling direction of the mobile object is not the advance-prohibited signal indication with turning-permitted signal indication; and providing, via a notification unit, a predetermined notification to draw an attention at a time of turning based on the determined notification mode.

### Advantageous Effects of Invention

The present invention provides the turn collision prevention support depending on the signal indication of the traffic signal for the traveling direction of the local vehicle. Specifically, when the signal indication of the traffic signal for the traveling direction of the local vehicle is the advance-prohibited signal indication with turning-permitted signal indication (e.g., red signal indication with the right-turn arrow), the notification mode is determined regardless of the presence or absence of another vehicle (e.g., notification is not provided, or a notification to encourage right turn is provided even when a vehicle that is going to travel straight is present in the opposing traffic lane), thus achieving smooth traffic or prevent an excessive support.

### BRIEF DESCRIPTION OF DRAWINGS

FIG. 1 is a block diagram illustrating a configuration of a navigation device of the present invention.

FIG. 2 is a first flowchart illustrating the flow of processing that a control unit of the navigation device of the present invention performs.

FIG. 3 shows an example of a notification content table to be stored in a notification content table storage unit of the navigation device according to a first embodiment of the present invention.

FIG. 4 is a first flowchart illustrating the flow of processing that the control unit of the navigation device of the present invention performs.

FIG. 5 is a first conceptual diagram of a service for turn collision prevention support.

FIG. 6 is a second conceptual diagram of a service for turn collision prevention support.

### DESCRIPTION OF EMBODIMENTS

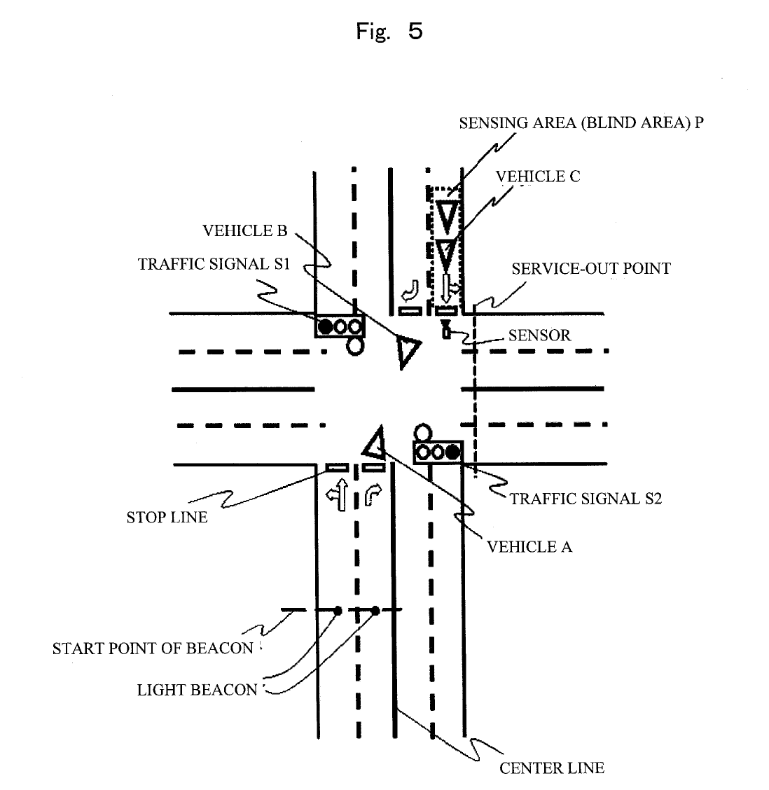

Before describing embodiments of the present invention, first, sensor information is described with reference to FIG. 5. The sensor information is information output from a sensor as described above, and includes information indicating the range of a sensing area (information on a sensing area) and information on a vehicle present in the sensing area. A plurality of sensors are installed around, for example, an intersection, and each sensor monitors a sensing area that is set around the intersection and transmits the detection result to an information relay and determination device. The range of the sensing area may be appropriately set. In this embodiment, the range of the sensing area is an area which is considered to be a blind spot for the driver of a vehicle that makes turn, so that when a vehicle present in the area travels straight, the vehicle may collide with the local vehicle.

The range of a sensing area P illustrated in FIG. 5 is exemplified. According to this embodiment, the start point of the sensing area P is a point apart by a stopping sight distance from the position coordinates of a stop line (stop line for the vehicle C) in a direction opposite to the traveling direction of the vehicle C, and the end point of the sensing area P is the position coordinates of the stop line (stop line for the vehicle C). This is because with the stopping sight distance apart from the position coordinates of the stop line, the driver of the vehicle C may recognize the presence of the vehicle A and take a collision prevention action such as deceleration (in other words, a collision does not occur even if the vehicle A directing turns right), and when the vehicle C exceeds the position coordinates of the stop line, the driver of the vehicle A may visually recognize the presence of the vehicle C. However, as mentioned above, the range of the sensing area P is just illustrative, and not restrictive. It should be noted that although the range of the sensing area P is determined based on the position coordinates of the stop line in this embodiment, the range is not restrictive, and may be determined based on position coordinates available as the position of an intersection, such as the position coordinates of the center of the intersection or the position coordinates of the node of the intersection.

Information indicating the start point/end point of the sensing area P (information on the sensing area P) is indicated by the position coordinates of a light beacon (which may be the current position upon reception of information from the light beacon) and a traveling distance from the position coordinates of the light beacon (distance to a target point, which is measured along a road), the position coordinates of an intersection and a road distance from the position coordinates of the intersection, the latitude and longitude (the position coordinates of the start point/end point of the sensing area P), and so forth.

The design speed may be the limiting speed on a road, but the design speed may be, for example, the limiting speed +10 km/h on the assumption of running over the limiting speed, or may be determined based on the shape of a road (for example, when the current position of the local vehicle is in a sharp curve, the vehicle is assumed to be running at a speed slower than the limiting speed so that the design speed is set to the limiting speed −10 km/h).

Next, information on a vehicle present in the sensing area is described. The information on a vehicle present in the sensing area includes information indicating the type of the vehicle present in the sensing area (large vehicle, medium-sized vehicle, regular vehicle, motorcycle, or the like), information indicating the number of vehicles, information indicating the current position of a vehicle, and information indicating the moving speed of a vehicle. According to the present invention, based on sensor information, it is determined whether or not there is another vehicle that may collide with the local vehicle, as described later. When sensors can detect pedestrians or the like present in the sensing area, the sensor information may include information on the pedestrians (information indicating the number of pedestrians, the current positions thereof, and moving speeds thereof).

The embodiment of the present invention is described below referring to the drawings. It should be noted that the embodiment described below is a navigation device which is an example of a mobile communication device according to the present invention that embodies the technical concept of the present invention, is not intended to limit the present invention to this navigation device, and may be equally adaptable to devices of other embodiments included in the claims. For example, the device may not have a navigation function. Although the following description exemplifies a case where the navigation device is mounted on an automobile, a motorcycle or the like may be equipped with the navigation device.

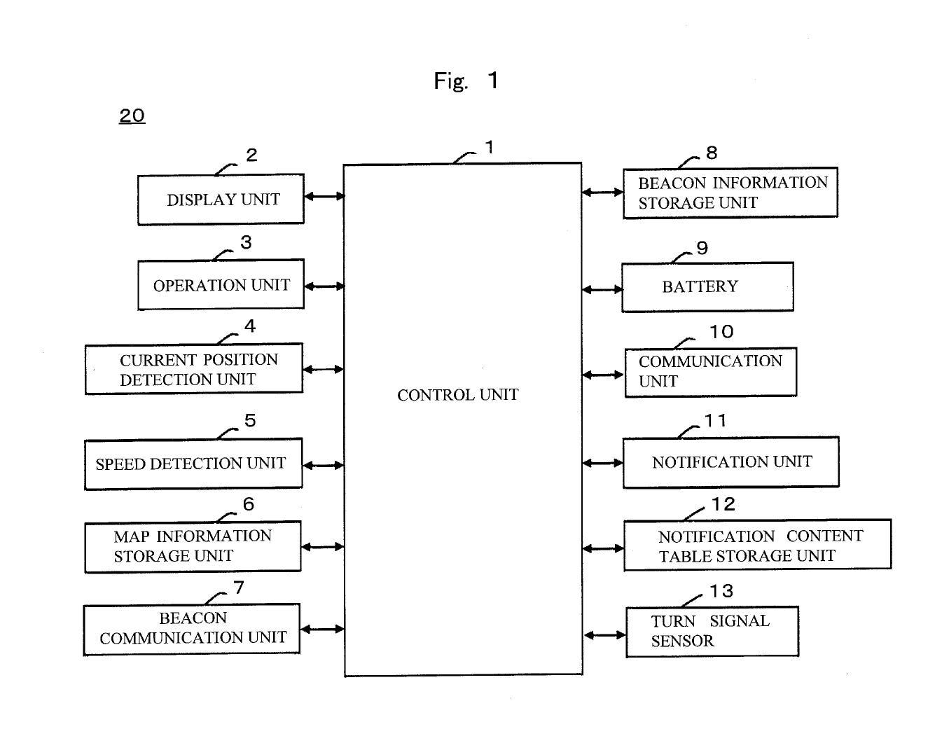

FIG. 1 is a block diagram illustrating the configuration of the navigation device of the present invention. A navigation device 20 includes a control unit 1, a display unit 2, an operation unit 3, a current position detection unit 4, a speed detection unit 5, a map information storage unit 6, a beacon communication unit 7, a beacon information storage unit 8, a battery 9, a communication unit 10, a notification unit 11, a notification content table storage unit 12, and a turn signal sensor 13.

The control unit 1 is control means for generally controlling the overall navigation device 20. The control unit 1 includes a CPU, a ROM, and a RAM (none shown). Stored in the ROM are programs that are executed by the control unit 1, and parameters and data that are necessary for executing the programs. The CPU executes various programs stored in the ROM. The RAM temporarily stores data obtained in the course of performing various processes, and data obtained as a result of performing various processes. These CPU, RAM, ROM, etc. are interconnected by buses. The CPU, ROM, and RAM may be partially or entirely integrated into a single chip.

The display unit 2 is display means for displaying a map screen (screen showing a map image including a route to a destination, and a mark indicative of the current position of a vehicle on which the navigation device 20 is mounted (in the following, “vehicle on which the navigation device 20 is mounted” may be called “local vehicle”)), and a menu screen.

The operation unit 3 is input operation means for allowing a user to input a destination and operate the menu. As the operation unit 3, various keys and buttons may be provided on the main body of the navigation device 20, or the display unit 2 may be provided with a touch panel function. Further, as the operation unit 3, a remote controller for remotely operating the main body of the navigation device 20 may be used as the operation unit 3.

The current position detection unit 4 detects the current position of the local vehicle, and is configured to include a GPS receiver, self-contained navigation means, and a CPU for calculating the position. The self-contained navigation means includes an operation angle sensor, an acceleration sensor, a distance sensor, and an azimuth sensor to detect the traveling distance and the traveling direction of the local vehicle, and obtain the current position thereof based on these values. Further, the GPS receiver receives radio waves transmitted from a plurality of GPS satellites by a GPS antenna, and calculates the absolute position and the traveling direction of the local vehicle by performing three-dimensional positioning or two-dimensional positioning. The traveling direction is calculated based on the current position of the local vehicle and the previous position of the local vehicle. The method of detecting the traveling direction is not particularly limited, and may be detected from, for example, the rotational direction of the tires, or may be detected using the azimuth sensor. Further, a traveling-direction detection unit may be provided in addition to the current position detection unit 4 to detect the traveling direction of the local vehicle.

The speed detection unit 5 detects the moving speed of the local vehicle. The moving speed may be calculated from the output of a vehicle speed sensor or the acceleration sensor, or may be calculated from the difference in the traveling distance and in the time of GPS reception between the GPS histories. The moving speed of the local vehicle may be detected by the current position detection unit 4. When the current position detection unit 4 can detect the moving speed in addition to the current position of the local vehicle, the speed detection unit 5 may not be provided separately. In this case, the current position detection unit 4 is configured to include the speed detection unit 5.

The operation angle sensor, the acceleration sensor, the speed sensor, the azimuth sensor, etc. may be provided in the navigation device 20, or a vehicle (local vehicle) may include the above-mentioned various sensors, and the navigation device 20 may be configured to include an interface to obtain the outputs of the various sensors.

Map information which is referred to when performing route search to a destination or navigation is stored in the map information storage unit 6. The map information includes network data (node data and link data). Further, the map information may include map images, or map images may be rendered on the display unit 2 based on the network data (node data and link data) included in the map information. Instead of being stored in the map information storage unit 6 in advance, map information may be received from roadside devices or the like by the communication unit 10 to be described later, and the received map information may be stored in the map information storage unit 6.

It should be noted that a storage medium such as a NAND flash or an SD memory card may be suitably used as the map information storage unit 6 and the beacon information storage unit 8 and notification content table storage unit 12 which are described later. The individual storage units may share a single storage medium, or may have storage media, respectively. Further, the individual storage units may be built in the navigation device 20, or may be configured to be mountable to and dismountable from the navigation device 20.

In the present invention, the network data includes node data and link data of roads. In specifying a road on which the local vehicle is currently traveling, the control unit 1 can specify the road by performing map matching based on the current position of the local vehicle detected by the current position detection unit 4 (traveling direction and moving speed may also be added) and map information.

It should be noted that the map matching process may be performed by the control unit 1 or may be performed by the current position detection unit 4. In other words, map matching may be performed based on the current position detected by using the GPS receiver and/or the self-contained navigation means and the map information, and the current position obtained through map matching may be output as the current position to the control unit 1. Alternatively, the current position detection unit 4 may include the map matching process of the control unit 1.

The beacon communication unit 7 receives various information from the light beacons installed on a road. The light beacons installed on a road can limit the communication range to within the width of a single traffic lane, so that the light beacons installed for each traffic lane can transmit beacon information only to vehicles traveling on a specific lane.

The information received from the light beacons by the beacon communication unit 7 is provided downlink information registered by the information relay and determination device as described above, and includes system information, sensor information, intersection information, traffic signal information, road shape information, control information, and traffic lane information. Those pieces of information may be received from roadside devices or the like via the ITS by the communication unit 10 to be described later in addition to reception from the light beacons by the beacon communication unit 7.

Each information is briefly described now. The system information includes information indicating the contents of the provision service provided at an intersection, and additionally includes information indicating a service providing time, and the operational state of the service. With the system information obtained, the control unit 1 can determine what kind of driving support service can be provided to the driver. This embodiment relates to the case where a system of supporting turn collision prevention is included as the provision service in the system information, so that the navigation device 20 is premised to have a function of performing a turn collision prevention support for the driver.

As described above, the sensor information includes information indicating the position (range) of a sensing area, and information indicating the types of vehicles present in the sensing area, the number of vehicles and pedestrians, the current position, and the moving speed. With the sensor information obtained, the control unit 1 can determine the state of the sensing area (presence of a vehicle traveling towards an intersection, or the like).

The intersection information includes information such as the position coordinates (latitude and longitude) of the center of the intersection, an identification number of a traffic signal (traffic signal number) associated with the direction of entering the intersection (road direction), information for identifying a roadside device (intersection), the position coordinates of a stop line (the position (latitude and longitude) of the stop line associated with the direction of entering the intersection (road direction)), and node data of points to be the start point and end point of the intersection (position coordinates of the node of the intersection). As described later, traffic signal information of a traffic signal that controls traffic of the local vehicle is discriminated based on the intersection information.

The traffic signal information includes information such as identification information (traffic signal number) for identifying a traffic signal, the position coordinates (latitude and longitude) of a traffic signal (position where the traffic signal is provided), information on current signal indication of a traffic signal (information indicating display color of the traffic signal), information indicating a time for the current signal indication to change to a next signal indication, and the indication order of signal indications (information indicating the cycle of signal indications), and those pieces of information are associated with one another. In other words, the traffic signal information can be said to include information by which the signal indication of a traffic signal at a given time (current time or an arbitrary time after the current time) and/or the time for the signal indication at a given time to change to a next signal indication can be specified.

The road shape information is information indicating a road structure in a target road zone (intersections and single road), and includes, for example, information indicating a traveling distance to a stop line from a light beacon and the connection angle of the road or the like.

The control information is information indicating the traffic control of a target zone and intersections, and includes information indicating the type of control, the types of vehicles to be controlled, and a control time.

The traffic lane information can permit specification of a traffic lane on which the local vehicle is currently traveling (traveling traffic lane of the local vehicle), and includes, for example, information indicating which lane in what number of lanes the local vehicle is traveling, and information indicating the attribute of the traveling traffic lane of the local vehicle such as an exclusive lane for the right-turn traffic or an exclusive lane for the straight-advancing traffic.

The beacon information storage unit 8 stores the beacon information received by the beacon communication unit 7.

The battery 9 is power supply means used when the navigation device 20 is used in a portable mode; a secondary battery such as a lithium-ion battery or a nickel hydride battery, may be used suitably. Of course, a primary battery such as an alkali manganese dry cell or a manganese dry cell, may be used as the battery 9, or a fuel cell may be used as well.

The communication unit 10 includes a transmission unit (not shown) that transmits information to another communication device (hereinafter referred to as “another communication device”) that can communicate to/from the navigation device 20, and a reception unit (not shown) that receives information transmitted from the another communication device. The communication method is preferred to be non-contact communication such as wireless communication and infrared communication. Examples of the another communication device include an in-vehicle communication device such as a navigation device mounted on another vehicle (which may be a mobile communication terminal, such as a mobile phone, which is carried by a pedestrian when the pedestrian is on another vehicle), a roadside device, and a mobile communication terminal, such as a mobile phone, carried by a pedestrian or the like (pedestrian, the driver of a bicycle, or the like).

The information received from a roadside device by the communication unit 10 is the provided downlink information registered by the information relay and determination device as described above, and includes system information, sensor information, intersection information, traffic signal information, road shape information, and control information.

In this embodiment, the communication unit 10 receives the provided downlink information transmitted in the band of 700 MHz. The possible transmission range is a radius of about 300 m, and the navigation device 20 can acquire latest provided downlink information even after passing a light beacon (after receiving the provided downlink information from the light beacon).

The notification unit 11 is notification means for notifying the user of various kinds of information. Examples of the notification means, which is not particularly limited, include a voice guidance (voice output) that is carried out through a speaker (not shown), and a screen display of a text, an image, or the like that is carried out via the display unit 2. The voice output and the screen display may be performed simultaneously. Referring to the notification content table storage unit 12 to be described later, the control unit 1 determines the kind of contents of notification performed in the voice output and the screen display.

The notification content table storage unit 12 stores a table of contents of notification to be performed via the notification unit 11. The notification contents are stored in association with the signal indication of a traffic signal for the traveling direction of the local vehicle, as described later.

The turn signal sensor 13 detects the blinking state of a turn signal (direction indicating means) of the local vehicle. A known turn signal sensor may be used as the turn signal sensor 13, so that whether a turn signal is blinking and which turn signal is blinking (both or left side or right side) can be determined by detecting the blinking state of the turn signal.

### First Embodiment

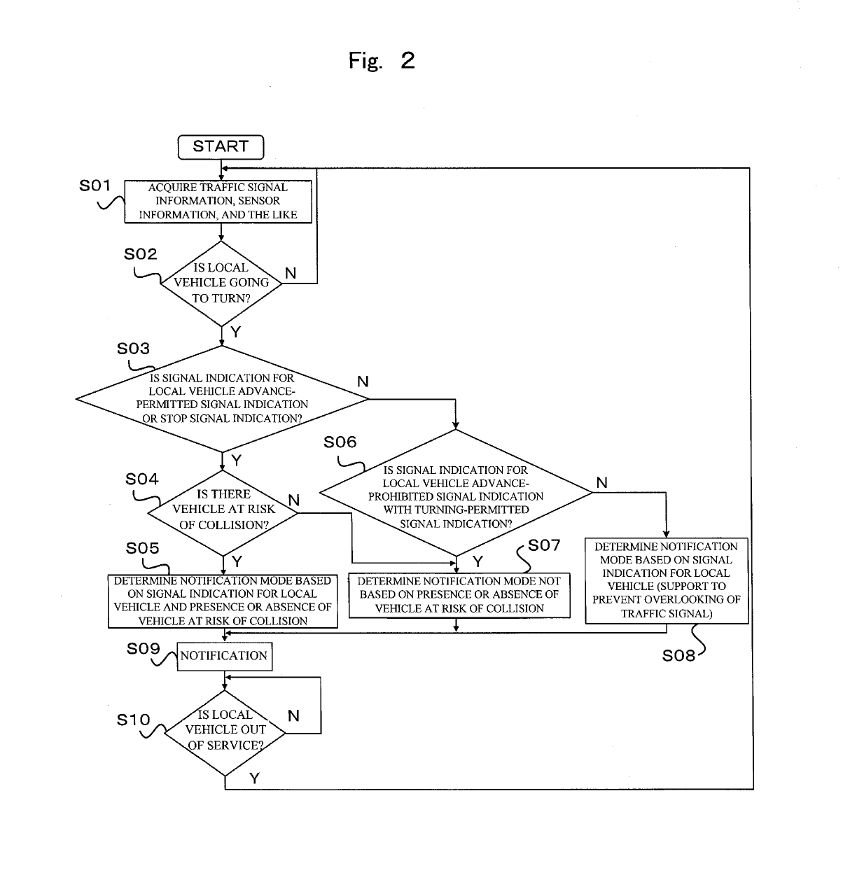

The navigation device 20 according to a first embodiment of the present invention is described referring to FIG. 2. FIG. 2 is a first flowchart illustrating the flow of processing that the control unit 1 of the navigation device 20 of the present invention performs.

In Step S01, the control unit 1 acquires information including intersection information, traffic signal information, and sensor information via the beacon communication unit 7 and the communication unit 10.

The timings at which the control unit 1 acquires the intersection information, the traffic signal information, and the sensor information are not limited to those timings. Those pieces of information may be acquired regularly or irregularly (e.g., based on the transmission timing of another communication device). In case of acquiring the information a plurality of times regularly or irregularly, latest information among the acquired information may be used. The processes of individual steps to be described later may be performed when latest mobile object information of the local vehicle, and latest intersection information and traffic signal information are acquired. The same holds true for the following embodiments.

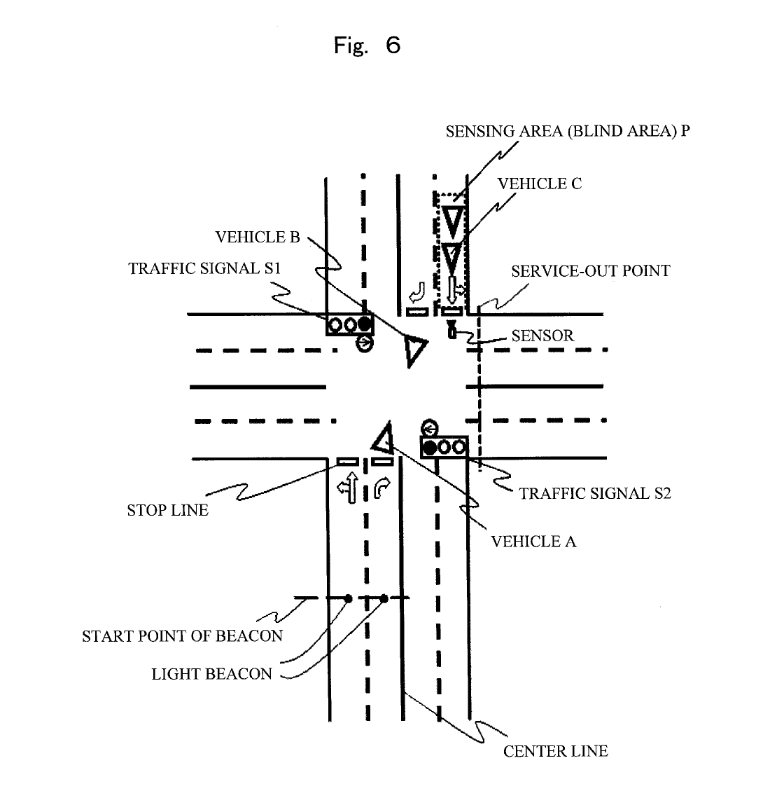

In Step S02, the control unit 1 determines whether or not the local vehicle is going to turn. The local vehicle is going to turn right in this embodiment as illustrated in FIGS. 5 and 6, and hence the control unit 1 determines whether or not the local vehicle is going to turn right in this step, but this embodiment is also applicable to the case where the local vehicle is going to turn left.

Whether or not the local vehicle is going to turn right can be determined by determining, for example, whether the current position of the local vehicle is on the exclusive right-turn lane, whether the local vehicle is showing the right-turn signal, or whether the intersection ahead is the intersection at which the vehicle is going to turn right (the intersection at which the vehicle is recommended, through the result of route search, to turn right at the traffic signal). It should be noted that whether or not the current position of the local vehicle is on the exclusive right-turn lane can be determined based on, for example, the traffic lane information acquired from light beacons, or through map matching based on the current position of the local vehicle and map information.

When the local vehicle is going to turn right (turning) (Y in Step S02), the process proceeds to Step S03, whereas when the local vehicle is not going to turn right (turning) (N in Step S02), the process returns to Step S01.

In Step S03, the control unit 1 determines whether or not the signal indication of a traffic signal for the traveling direction of the local vehicle (in the following, the “signal indication of a traffic signal for the traveling direction of the local vehicle” is referred to as “signal indication for the local vehicle”) is advance-permitted signal indication (green signal indication) or a stop signal indication (yellow signal indication). The information indicating the signal indication for the local vehicle is included in the traffic signal information. When the signal indication for the local vehicle is the advance-permitted signal indication (green signal indication) or the stop signal indication (yellow signal indication) (Y in Step S03), the process proceeds to Step S04, whereas when the signal indication for the local vehicle is not the advance-permitted signal indication (green signal indication) or the stop signal indication (yellow signal indication) (N in Step S03), the process proceeds to Step S06.

In this embodiment, the “traffic signal for the traveling direction of the local vehicle” means a “traffic signal ahead of the local vehicle.” The traffic signal ahead of the local vehicle is a traffic signal that controls the traffic of the local vehicle. In other words, the traffic signal ahead of the local vehicle is a traffic signal ahead in the traveling direction on a road on which the local vehicle is traveling. A traffic signal ahead can be specified based on the current position of the local vehicle, the traveling direction of the local vehicle, the intersection information, and the traffic signal information. Specifically, among traffic signals installed at an intersection on a road on which the local vehicle is traveling and whose position coordinates are closest to the current position coordinates of the local vehicle in the traveling direction (in the following, the “intersection on a road on which the local vehicle is traveling and whose position coordinates are closest to the current position coordinates of the local vehicle in the traveling direction” is referred to as “intersection ahead”), the traffic signal that is associated with the traveling direction of the local vehicle (traffic signal associated with the road direction in the same direction as the traveling direction of the local vehicle (the directions may not exactly match with each other, but may be regarded as the same direction when the directions are within a predetermined error range) is specified as a traffic signal ahead.

It should be noted that the traveling direction of the local vehicle at the time of specifying the traffic signal ahead is preferred to be the traveling direction (entering direction) at the time of entering the intersection ahead instead of the current traveling direction. The traveling direction at the time of entering the intersection ahead can be specified by specifying a link that connects to an intersection (node) ahead among nodes and links of the road on which the local vehicle is traveling, based on network data (node data and link data) included in the map information.

Further, in a case where the communication unit 10 (which may be the beacon communication unit 7) receives traffic signal information from a communication device such as a DSRC communication device or a light beacon communication device disposed in front of an intersection (when the communication unit 10 performs reception in a communication protocol with a narrow communication area), when single traffic signal information (traffic signal information of a single traffic signal) is transmitted from the communication device such as the DSRC communication device, this traffic signal information may be the traffic signal information of a traffic signal in front of the intersection ahead.

An intersection to arrive next (intersection ahead) may be specified based on the current position of the local vehicle, the traveling direction thereof, and network data (node data and link data). In this case, it is possible to specify an intersection node of the intersection ahead, and specify the traffic signal ahead based on the intersection information at which the position coordinates of the node match with the position coordinates of the center of the intersection to be included in the intersection information acquired via the communication unit 10, and on the traveling direction.

In this step, the position coordinates of an intersection are not limited to the position coordinates of the center of the intersection, and may be the position coordinates of a stop line placed at the intersection, or the position coordinates of a point to be the start point of the intersection (position coordinates of the node of the intersection).

First, a description is given of the case where the process proceeds to Step S04. In Step S04, the control unit 1 determines whether or not there is another vehicle that may make collision when the local vehicle turns (turns right) (in the following, “another vehicle that may make collision when the local vehicle turns (turns right)” is referred to as “vehicle at a risk of collision”). Whether or not there is a vehicle at a risk of collision can be specified based on the sensor information. As described above, another vehicle present in the sensing area is a vehicle that may make collision when the local vehicle turns in this embodiment. When there is a vehicle in the sensing area, therefore, it is determined that there is a vehicle at a risk of collision.

When there is a vehicle at a risk of collision (Y in Step S04), the process proceeds to Step S05, whereas when there is not a vehicle at a risk of collision (N in Step S04), the process proceeds to Step S07. Although the process proceeds to Step S07 described later when there is not a vehicle at a risk of collision in this embodiment, the process may return to Step S01. It should be noted however that it is desired to provide a turn collision prevention support (to proceed to Step S07) in consideration of possible presence of a vehicle at a risk of collision, such as in a case where a vehicle traveling at a speed significantly higher than the design speed is present on an opposing traffic lane, or in a case where a vehicle present in the sensing area cannot be detected due to poor detection accuracy of the sensors. The process when there is not a vehicle at a risk of collision is not limited to the process of Step S07, and may be set up as needed.

In Step S05, the control unit 1 determines a notification mode based on the signal indication for the local vehicle and the presence or absence of a vehicle at a risk of collision. According to the present invention, “to determine the notification mode” is to determine whether or not a notification is made, and what kind of notification is made by the notification means if the notification is to be made. It should be noted that single means may be set up in advance as the notification means. Although the descriptions of this embodiment and the following embodiments are given of the case where the notification means in case of making a notification is set to the voice output by way of example, the control unit 1 may determine the notification means depending on the condition (e.g., the control unit 1 determines whether the screen display is set or the voice output is set). When the notification means is set to the voice output, the volume of sound may be determined together with the contents of the notification. When there is a high risk (e.g., when the signal indication for the local vehicle is a green signal indication (advance-permitted signal indication) and there is a vehicle at a risk of collision (in other words, the determination in Step S04 is YES), for example, increasing the sound volume can draw the attention of the user.

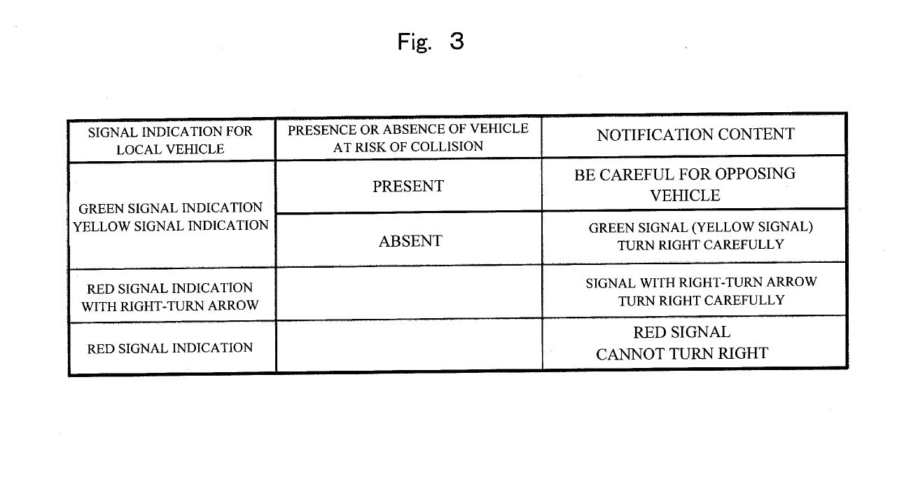

In determining the contents of the notification, the control unit 1 refers to the notification content table stored in the notification content table storage unit 12 to make the determination. FIG. 3 shows an example of the notification content table stored in the notification content table storage unit 12 included in the navigation device 20 according to this embodiment. As shown in FIG. 3, each notification content is stored in association with at least the signal indication for the local vehicle.

Next, a description is given of a case where the process proceeds to Step S06. In Step S06, the control unit 1 determines whether or not the signal indication for the local vehicle is the advance-prohibited signal indication with turning-permitted signal indication (red signal indication with the right-turn arrow). When the signal indication for the local vehicle is the advance-prohibited signal indication with turning-permitted signal indication (red signal indication with the right-turn arrow) (Y in Step S06), the process proceeds to Step S07, whereas when the signal indication for the local vehicle is not the advance-prohibited signal indication with turning-permitted signal indication (red signal indication with the right-turn arrow) (N in Step S06), the process proceeds to Step S08. The case where the signal indication for the local vehicle is the advance-prohibited signal indication with turning-permitted signal indication (red signal indication with the right-turn arrow) in Step S06 is the case where the signal indication for the local vehicle is the advance-prohibited signal indication (red signal indication).

In Step S07, the control unit 1 determines the notification mode based on the signal indication for the local vehicle (to be supplementary, not based on the presence or absence of a vehicle at a risk of collision). In Step S08, the control unit 1 determines the notification mode based on the signal indication for the local vehicle. Although Step S07 and Step S08 both determine the notification mode based on the signal indication for the local vehicle, the contents of the notification differ significantly. In other words, for Step S07 which concerns a notification when the driver of the local vehicle turns right, it is desired to give a notification to urge to turn right and prompt an attention on the presence of a potential vehicle at a risk of collision. By way of contrast, Step S08 gives a notification when the driver of the local vehicle cannot turn right, and hence the process need not prompt an attention on the presence of a vehicle at a risk of collision, but gives a notification to prompt an attention on the signal indication.

In Step S09, the control unit 1 makes a predetermined notification to draw an attention at the time of turning based on the notification mode determined in Step S05, Step S07, or Step S08 via the notification unit 11. The notification contents may prompt a minimum attention depending on the condition as shown in FIG. 3.

In Step S10, the control unit 1 determines whether or not the local vehicle is out of service. In this embodiment, the out of service means outside of the period of providing a turn collision prevention support (provision zone), and the control unit 1 determines that the local vehicle is out of service when the local vehicle passes a service-out point (included in the map information). The determination of whether or not the local vehicle is out of service is not limited to this mode, and it may be determined that the local vehicle is out of service, for example, when the local vehicle (driver of the local vehicle) completes a right turn. When the local vehicle is out of service (Y in Step S10), the process returns to Step S01, whereas when the local vehicle is not out of service (N in Step S10), the process returns to Step S09 to keep providing the turn collision prevention support (notification of Step S09).

In this embodiment, a turn collision prevention support is provided depending on the signal indication for the local vehicle. Specifically, when the signal indication for the local vehicle is the red signal indication with the right-turn arrow, the notification mode is determined regardless of the presence or absence of a vehicle at a risk of collision (another vehicle), thus making it possible to ensure smooth traffic and prevent excessive support.

### Second Embodiment

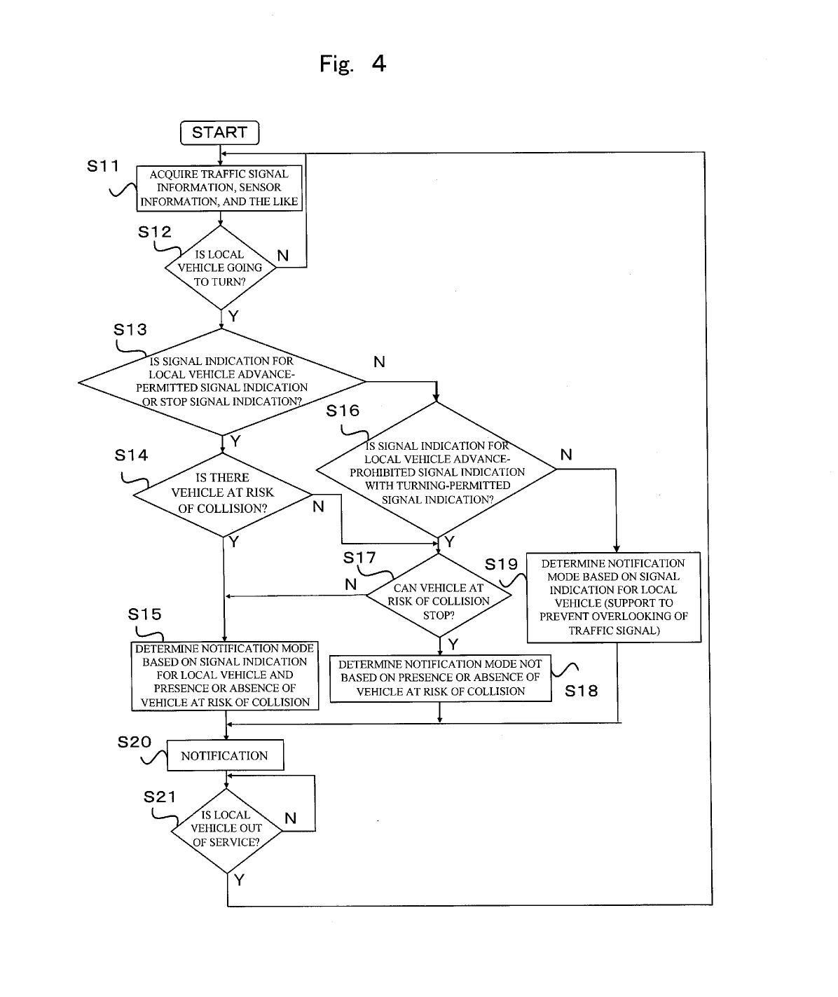

The navigation device 20 according to a second embodiment of the present invention is described referring to FIG. 4. FIG. 4 is a second flowchart illustrating the flow of processing that the control unit 1 of the navigation device 20 of the present invention performs. Steps S11 to S16 and S18 to S21 in this embodiment are the same as Steps S01 to S06 and S07 to S10 in the first embodiment, respectively, and hence descriptions thereof are omitted.

In Step S17, the control unit 1 determines whether or not a vehicle at a risk of collision can stop. In the first embodiment described above, when the signal indication for the local vehicle is the red signal indication with the right-turn arrow, the signal indication for the vehicle at a risk of collision is the red signal, and hence the process proceeds to Step S07 in the first embodiment (Step S18 in this embodiment) where the control unit 1 determines the notification mode based on the signal indication for the local vehicle (to be supplementary, not based on the presence or absence of a vehicle at a risk of collision). However, even when the signal indication for the local vehicle is the red signal indication with the right-turn arrow, immediately after the signal indication for the local vehicle becomes the red signal with the right-turn arrow, a vehicle at a risk of collision which has entered the intersection at the timing at which the yellow signal changes to the red signal may travel straight. In addition, for some cases, there may be a vehicle at a risk of collision which enters the intersection immediately after the signal changes to the red signal. Even if the signal indication for the local vehicle is the red signal indication with the right-turn arrow, therefore, when the vehicle at a risk of collision cannot stop at the stop line, it is desired to determine the notification mode based on the signal indication for the local vehicle and the presence or absence of a vehicle at a risk of collision (to proceed to Step S15).

Whether or not a vehicle at a risk of collision can stop can be determined based on, for example, the distance to the stop line from the current position of the vehicle at a risk of collision, the moving speed of the vehicle at a risk of collision, and the stop distance (distance obtained by adding the free running distance (the distance that a vehicle travels from the point of time when the driver considers to step on the brake pedal and actually steps on the brake pedal until the braking actually takes an effect) and the braking distance (the distance a vehicle travels from the point of time when the braking takes an effect until the vehicle is set to the desired speed). In addition, when the control unit 1 acquires information indicating that the driver of the vehicle at a risk of collision is stepping on the brake pedal through vehicle-to-vehicle communication or the like, the control unit 1 may determine that the vehicle at a risk of collision can stop.

When the vehicle at a risk of collision can stop (Y in Step S17), the process proceeds to Step S18, whereas when the vehicle at a risk of collision cannot stop (N in Step S17), the process proceeds to Step S15.

This embodiment demonstrates effects similar to those of the first embodiment. In addition, when a vehicle at a risk of collision seems to enter an intersection without stopping at the stop line even if the signal indication for the local vehicle is the red signal with the right-turn arrow, the notification mode is determined based also on the presence or absence of the vehicle at a risk of collision (another vehicle), so that safer traveling support can be provided.

### Other Embodiment

The individual notification contents in the notification content table shown in FIG. 3 are stored in association with the green signal indication, the yellow signal indication, the red signal indication with the right-turn arrow, and the red signal indication, but the notification contents may be associated with other signal indications (e.g., red signal indication with the left-turn arrow). With regard to the signal indication cycle of a traffic signal that shows a red signal indication with an arrow, the yellow signal is indicated twice in one signal indication cycle. The first yellow signal indication and the second yellow signal indication may be treated separately, so that the first yellow signal indication is treated in the same way as the green signal indication as shown in FIG. 3, and the second yellow signal indication is treated in the same way as the red signal indication with the right-turn arrow or the red signal indication. The contents of the notification when the second yellow signal indication is treated in the same way as the red signal indication with the right-turn arrow may be “Yellow signal. Turn right carefully.”

Although it is determined whether or not the signal indication for the local vehicle is the advance-prohibited signal indication with turning-permitted signal indication in the above-mentioned embodiments, this description is for the case where the signal indication for the local vehicle is the same as the signal indication for the direction opposite to the traveling direction of the local vehicle (namely, the signal indication of a traffic signal S2 in FIG. 5).

In other words, determining whether or not the signal indication for the local vehicle is the advance-prohibited signal indication with turning-permitted signal indication is to determine whether or not the signal indication for the direction opposite to the traveling direction of the local vehicle (namely, the signal indication of the traffic signal S2 in FIG. 5) permits traveling straight or turning left.

### INDUSTRIAL APPLICABILITY

The present invention can be used for a mobile communication device and a traveling support method that are capable of providing a turn collision prevention support to prevent a collision with another mobile object at the time of turning.

This application claims priority from Japanese Patent Application No. 2011-281821, filed on Dec. 22, 2011 in the Japan Patent Office, the entire disclosure of which is incorporated herein by reference.

### REFERENCE SIGNS LIST

1 control unit

2 display unit

3 operation unit

4 current position detection unit

5 speed detection unit

6 map information storage unit

7 beacon communication unit

10 communication unit

11 notification unit

12 notification content table storage unit

13 turn signal sensor

20 navigation device

1. A mobile communication device, which is provided in a mobile object and capable of providing a turn collision prevention support to prevent a collision with another mobile object at a risk of collision when the mobile object turns, the mobile communication device comprising:
a communication unit for receiving information including information indicating a signal indication of a traffic signal; and
a control unit for determining a notification mode to provide a predetermined notification to draw an attention at a time of turning via a notification unit,
wherein when the signal indication of the traffic signal in a traveling direction of the mobile object is an advance-prohibited signal indication with turning-permitted signal indication, the control unit determines the notification mode regardless of whether or not the another mobile object is present.

2. A mobile communication device according to claim 1, wherein the control unit further determines whether or not the another mobile object is stoppable before colliding with the mobile object, and determines the notification mode regardless of whether or not the another mobile object is present only when the signal indication of the traffic signal in the traveling direction of the mobile object is the advance-prohibited signal indication with turning-permitted signal indication, and when it is determined that the another mobile object is stoppable before colliding with the mobile object.

3. A mobile communication device according to claim 1, wherein the another mobile object comprises a vehicle present in a sensing area.

4. A mobile communication device according to claim 1, wherein the traffic signal is ahead of the mobile object.

5. A mobile communication device according to claim 1, wherein when the signal indication of the traffic signal in the traveling direction of the mobile object is an advance-permitted signal indication or a stop signal indication, the control unit determines the notification mode based on presence of the another mobile object.

6. A mobile communication device according to claim 1, wherein when the signal indication of the traffic signal in the traveling direction of the mobile object is an advance-prohibited signal indication, the control unit determines the notification mode based on the signal indication of the traffic signal.

7. A traveling support method, comprising the steps of:
acquiring information including information indicating a signal indication of a traffic signal;
determining whether or not the signal indication of the traffic signal in a traveling direction of the mobile object is an advance-prohibited signal indication with turning-permitted signal indication;
determining a notification mode regardless of whether or not another mobile object is present when the signal indication of the traffic signal in the traveling direction of the mobile object is the advance-prohibited signal indication with turning-permitted signal indication; and
providing, via a notification unit, a predetermined notification to draw an attention at a time of turning based on the determined notification mode.
